(19) United States
(12) Patent Application Publication
(10) Pub. No.: US 2014/0225840 A1
(43) Pub. Date: Aug. 14, 2014

(54) TOUCHSCREEN SYSTEM HAVING ON-PANEL TOUCH DRIVER CIRCUITRY

(71) Applicant: APPLE INC., Cupertino, CA (US)

(72) Inventors: Abbas Jamshidi-Roudbari, Sunnyvale, CA (US); Cheng-Ho Yu, Cupertino, CA (US); Ting-Kuo Chang, Cupertino, CA (US); Shih Chang Chang, Cupertino, CA (US)

(73) Assignee: Apple Inc., Cupertino, CA (US)

(21) Appl. No.: 13/767,242

(22) Filed: Feb. 14, 2013

(51) Int. Cl. G06F 3/041

(52) U.S. Cl. CPC G06F 3/041
USPC 345/173

(57) ABSTRACT

A touchscreen system has a light transparent panel, a region of display elements below the panel, and a transparent conductor plate that overlays the region of display elements. The transparent conductor plate is made of a number of electrode segments. Touch driver circuits are positioned on the panel and in a border region thereof. Each touch driver circuit has a respective latch and a respective output stage. The output stage is coupled to a respective one of the electrode segments and has a signal input to receive a touch stimulus signal. The touch driver circuits may be operated in shift register fashion so that the touch stimulus signal is pulsed sequentially to the electrode segments. Other embodiments are also described and claimed.

An embodiment of the invention relates to electronic circuit designs for achieving narrow border touchscreen panels. Other embodiments are also described.

### BACKGROUND

Touchscreens are prevalent in many applications, including of course in consumer electronics devices such as smartphones, tablet devices, and laptop and desktop computers. The display function in such devices is typically performed by a liquid crystal display (LCD), plasma, or organic light emitting diode (OLED) display element array that are connected to a grid of source (data) and gate (select) metal traces or lines. The display element array is attached to or formed on a transparent panel, such as a glass panel, which serves as a protective shield. The data and select lines of the display element array are connected to a display driver integrated circuit (IC). The driver IC receives an image or video signal, which it then decodes into raster scan image (color) values and writes them to the display element array during each frame by driving the data and select lines. This process is repeated at a high enough frame rate so as to render video.

The touch gesture detection function in such devices is typically performed using a capacitance sensing subsystem in which a conductive touch transducer grid structure that overlays the display element array is driven and sensed by a touch controller integrated circuit (IC). The touch sensing is typically performed during a blanking interval portion of a display frame, and in particular during a touch interval portion of a frame, while the display function is performed during a display interval portion of the frame.

The touch transducer grid structure can be implemented as a light transparent electrode plate that is formed on a rear surface of the protective panel. In some cases, the transparent electrode plate also connects to the display elements, serving to deliver a “common voltage” to the connected display elements from a voltage source circuit often referred to as a Vcom conditioning circuit. The Vcom conditioning circuit helps improve the display function by adjusting a voltage on the transparent conductor plate that changes the light modulation characteristics of each connected display element (during the display interval). The transparent electrode plate has been dual purposed in that it is used for both the display function and as the touch transducer grid structure (for the touch function), as follows. During each display interval, the Vcom conditioning circuit maintains segments of the transparent electrode plate at a certain voltage, in order to improve display performance. During each touch interval, however, the Vcom conditioning circuit is disabled to allow a touch stimulus signal (produced by the touch controller IC) to be applied to the row segments of the transparent electrode plate, while simultaneously sensing the column segments (to detect a single-touch or a multi-touch gesture). To enable this touch sensing function, each row segment of the transparent electrode plate is separately routed or connected, via a separate signal trace, to a voltage source that generates the stimulus signal for that row. That voltage source is part of the touch controller IC, which is located off-panel. A flex circuit that is connected to the transparent electrodes on the panel serves to route the individual stimulus signals of the row segments, from the touch controller IC. The sense signals from the column segments may also be routed to the off-panel touch controller, via a flex circuit. The display driver IC however is often cased and installed directly on the panel, e.g. using a chip on glass fabrication technique.

### SUMMARY

In accordance with an embodiment of the invention, a touchscreen system is described which may have a narrower border region on its light transparent panel. The border region may be defined as the area between an outer edge of a transparent electrode plate and an outer edge of the panel. The border region may be to the left of the plate, or to the right. The transparent conductor plate may be formed on the panel, and overlays a region or array of display elements. The plate is made, at least in part, of a number of first transparent electrode segments. In one embodiment, the first electrode segments are row-oriented or horizontal oriented segments. In one embodiment, the plate is electrically coupled to the display elements, so that the electrode segments can be used to apply certain voltages to the display elements, during a display interval portion of a frame (or a display mode of operation of the touchscreen system).

The system also has a number of touch driver circuits that are positioned on the panel and in the border region. In one embodiment, each touch driver circuit is made essentially of thin film transistors (TFTs), e.g. TFTs on glass. Each touch driver circuit has a respective latch and a respective output stage. The latch has a clock input, and also has an output that is coupled to a control input of its output stage. The output stage is coupled to a respective one of the first electrode segments, and also has a signal input to receive a touch stimulus signal, such that a single touch stimulus signal is shared by several touch driver circuits. This approach may enable the touchscreen system to avoid the wide metal traces in the border region that would have been needed to connect the row segments out to an on-panel flex circuit connector, where the flex circuit connector serves to deliver stimulus signals that are generated by off-panel touch controller stimulus circuitry. The wide metal traces are needed in a conventional touchscreen system in order to maintain low resistance in the traces, to ensure good touch performance. An embodiment of the invention may help free up some space in the border region, because the touch driver circuitry that is added (in lieu of the per row segment, stimulus traces) is expected to take less horizontal space in the border region. The beneficial impact here may be especially apparent when the panel size is larger, meaning a larger number of row segments and hence individual stimulus traces.

In one embodiment, a single stimulus signal is delivered to the touch driver circuits, either from an on-panel display driver integrated circuit or from an off-panel touch controller. The transparent conductor plate, which may have a grid structure of row segments and column segments, is sequentially pulsed along its row segments with the touch stimulus signal, during a touch interval or touch mode of operation of the system. This may be achieved by operating the touch driver circuits like a shift register, with the appropriate clock signals and a start pulse. At the same time, touch sensing may be conducted using the signals from the column segments, which have been routed to touch sense amplifier circuitry that may be off-panel, e.g. as part of the touch controller, or on-panel as part of the display driver IC.

In one embodiment, the output stage in each touch driver circuit has a respective pass gate that feeds a buffer gate. As such, the touch controller IC (or other voltage source that is generating the touch stimulus signal) sees relatively high impedance. The touch stimulus signal may be a square wave. In another embodiment, the output stage consists essentially of the pass gate without any subsequent buffer gate. This enables the touch stimulus signal pulse that is actually applied to the row segments to be, for example, a single frequency sinusoid, or a synthesized waveform shape. The single frequency sinusoid may help reduce the likelihood of interference or cross talk between adjacent row segments of the plate, due to being band limited.

In a further embodiment, two stimulus signals are used, enabling a two-phase stimulus operation where one touch stimulus signal is routed to the odd numbered row segments while the other is routed to the even numbered row segments. It is expected that such an embodiment may help improve signal to noise ratio of the touch sensing operation when, for example, the odd and even touch stimulus signals are 180° out of phase, thereby helping reduce interference or noise between adjacent pairs of row segments. This approach may require additional clock signals, particularly when each latch is coupled to drive a pair of pass gates (or, in other words, each pair of pass gates shares a latch), plus the additional routing or metal traces needed for the additional touch stimulus signal.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows a conventional touchscreen panel on which a region of display elements is formed, together with a transparent electrode plate that may be dual purposed for display and touch functions.

FIG. 2 shows an example conventional display element being a liquid crystal cell.

FIG. 3 is a circuit schematic of a touchscreen panel in accordance with an embodiment of the invention having on-panel touch driver circuitry.

FIG. 4 shows example touch sensing waveforms that may be used in the embodiment of FIG. 3.

FIG. 5 is a circuit schematic of another embodiment of the invention in which the output stage of the on-panel touch driver circuit consists essentially of a pass gate.

FIG. 6 shows example touch sensing waveforms that may be used in the embodiment of FIG. 5.

FIG. 7 is a circuit schematic of yet another embodiment of the invention in which a two-phase touch stimulation scheme is used.

FIG. 8 shows example touch sensing waveforms that may be used in the embodiment of FIG. 7.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

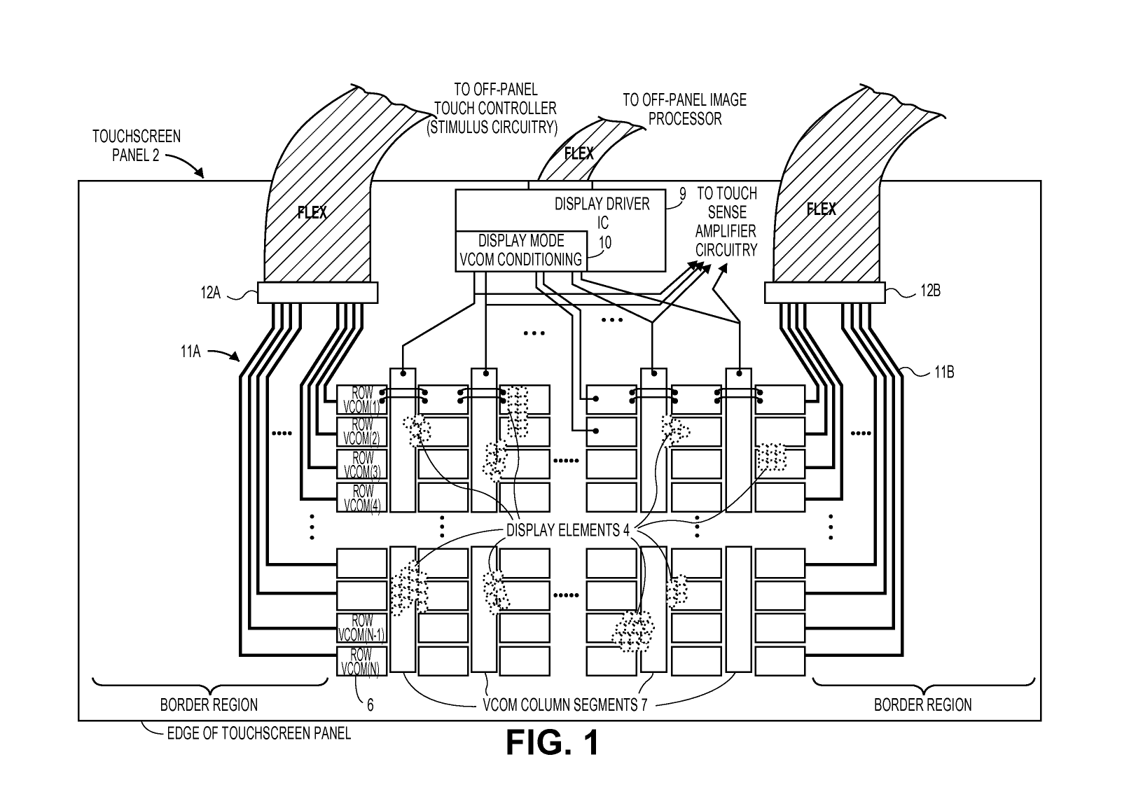

FIG. 1 shows a touch screen panel 2 which overlays a region of display elements 4, together with a transparent electrode plate formed on the panel 2. The light transparent panel 2 serves to carry electronic components, for example, a display driver IC 9 and on-panel touch driver circuitry to be described below, while simultaneously passing light that has been modulated (in accordance with image values for display) by a region of display elements 4.

The display elements 4 are located below the transparent conductor plate which in turn may be formed on a rear surface of the panel 2, and where a front surface of the panel 2 may be exposed to touch (including hovering of) a user's fingers. The touchscreen system is composed of the touchscreen panel 2, which is a light transparent panel that may be made of various materials and/or layers that are sufficiently light transparent, in order to allow light modulated by the display elements 4 to pass through and be visible to a human user, to enable a video display screen function. Examples include a glass panel or a polycarbonate panel or other sufficiently clear (light transparent) composite panel having one or more layers. A region of display elements 4 is formed below the panel 2.

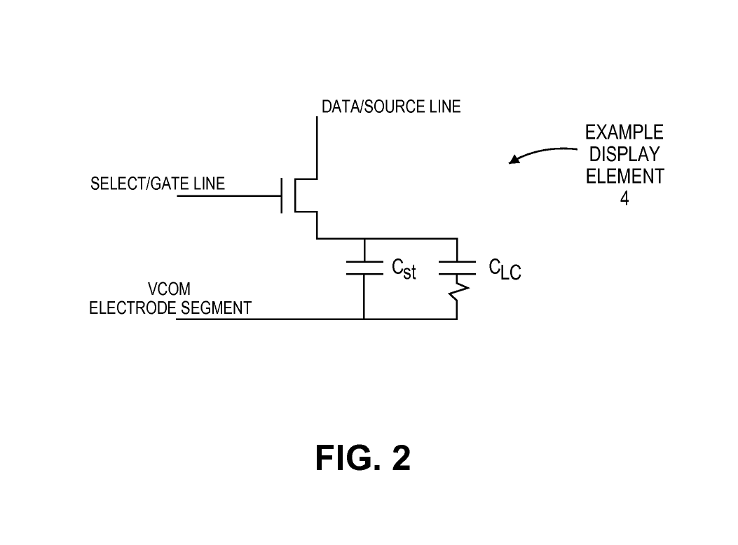

Each display element 4 generally serves to modulate light that has been produced by a light source (e.g., a backlight) or reflector, which may be either integrated with the touchscreen panel 2 “behind” the region of display elements 4, or emitted by the cell itself. In the case of a liquid crystal display (LCD) cell as shown in FIG. 2, the cell may have a liquid crystal capacitance C_{ic} that is formed between two layers, and may also have a storage capacitance Cₛₜ in parallel to enhance the signal storage ability of the display element. The LCD cell depicted in FIG. 2 is an active cell in that it contains a transistor that is connected to selectively apply a data or source line signal, which represents an image or color value, into the cell. The transistor may be a thin film transistor (TFT) that may be formed on a glass substrate. The example cell depicted in FIG. 2 has three external signal connections, including a source line that delivers an incoming voltage of an image or color to be displayed, a gate line signal that controls the TFT to apply the voltage to one plate of the liquid crystal capacitor, and a Vcom electrode segment line that connects to the other plate of the liquid crystal capacitor and serves to deliver a “common voltage” from a Vcom conditioning circuit 10—see FIG. 1. In the example shown, a row Vcom segment may have several sub-segments that are joined to one another by conductive bridges (overpass or underpass metal structures), that form essentially a row that may span a substantial portion if not the entire width of the display and touch active region of the touchscreen panel 12.

Still referring to FIG. 1, the display elements 4 are small relative to a single transparent electrode plate segment, namely a row Vcom segment 6 or a column Vcom segment 7. In one embodiment, each display element 4 is electrically connected to either a column Vcom segment 7 or a row Vcom segment 6. The segments 6, 7 are also connected to the display mode Vcom conditioning circuit 10 which may be part of a display driver IC 9 that, in this case, is installed directly on the touchscreen panel 2, e.g. via a chip-on-glass or other suitable interconnect technique. The display driver IC 9 is responsible for generating the needed timing signals (clock or control signals) as well as the analog pixel or color voltages that are written or applied to the display elements 4 in a raster scan manner. Typically, a given refresh rate is needed to update the color values stored in the display elements 4, where this rate depends on the particular leakage characteristics of each display element 4.

The transparent electrode plate may essentially consist of row Vcom segments 6 and column Vcom segments 7. The plate may be made of patterned indium tin oxide (ITO) layer whose constituent segments 6, 7 have been reinforced with a metal layer to increase conductance. The Vcom segments are used here to integrate touch functionality into a display screen, by providing the touch transducer grid structure which is a matrix used to sense a touch event by detecting capacitance changes for a particular grid location in the matrix. As such, the transparent electrode plate may be dual purposed in that it is also used by a touch controller (not shown) to detect single or multi-touch gestures on the external (front) surface of the touchscreen panel 2. A capacitive sensing approach may be implemented where a change in capacitance is measured for a given pair of row Vcom and column Vcom electrode segments. The touch function is performed typically during a blanking interval portion of each display frame, by applying a touch stimulus signal to a row Vcom segment 6, while simultaneously reading a signal on a Vcom column segment 7, using touch sensing amplifier circuitry (not shown).

As depicted in FIG. 1, the stimulus signals are routed through individual low impedance stimulus signal lines or traces 11A, 11B that are formed on the panel 2 in the left and right border regions, and through their respective flex circuits or carriers 12A, 12B. The flex carriers 12A, 12B serve to bring in the touch stimulus signals from stimulus generation or driver circuitry that is located off-panel as part of a touch controller. The load presented by each row Vcom segment 6 is such that a low impedance trace, i.e. a thick and/or wide metal trace, is needed from the row Vcom segment 6 to the driver (located off-panel in the touch controller).

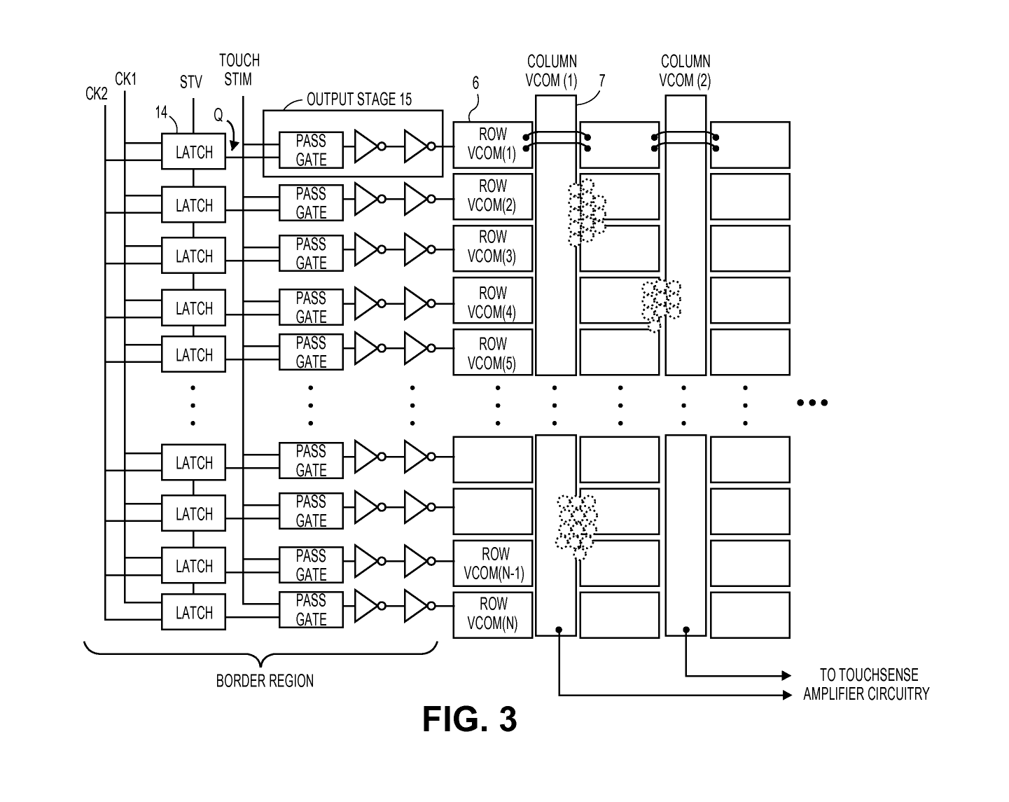

It has been discovered that in order to reduce the width of the border region, between the edge of the touchscreen panel 2 and a left or right edge of the region of display elements 4 (or between the panel edge and the edge of the transparent electrode plate), the individual (row Vcom) stimulus signal traces 11a, 11b may be essentially eliminated, in favor of on-panel touch driver circuitry in the border region. This means that there is no need to route wide metal traces from each and every row Vcom segment 6 out to the flex carriers 12A, 12B. Rather, only a handful of relatively thin signal line traces are needed to operate the on-panel touch driver circuitry. One embodiment is shown in FIG. 3, where a pair of clock signals CK1, CK2, a start pulse, STV, and a single touch stimulus signal are provided (in addition to power supply routing to each touch driver circuit—not shown).

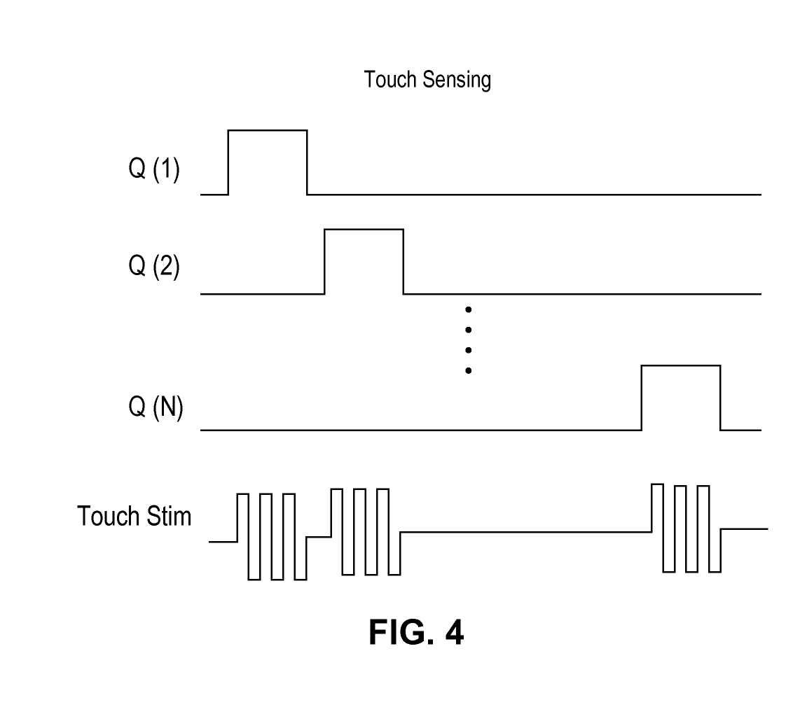

Referring to FIG. 3, each touch driver circuit is shown as being coupled to drive a respective row Vcom segment 6 (where in this case N+1 rows are shown as part of a left side of a touchscreen). Each touch driver circuit has a respective latch 14 that is coupled to drive its respective row Vcom segment 6 through a respective output stage 15. The first latch 14, associated with driving row Vcom (1), has a data input that receives the start pulse STV. The data input of each subsequent latch 14 is connected to a latch output of a “previous” touch driver. This arrangement enables a shift register type of operation, where the start pulse STV is sequentially shifted down the rows, beginning with row Vcom (1) and ending with row Vcom (N), in accordance with the pair of clock signals CK1, CK2. See the example waveforms in FIG. 4 which show the start pulse STV being propagated sequentially along the row Vcom segments 6, as represented by their respective latch outputs Q(1), Q(2), . . . to sequentially pulse the row Vcom electrode segments 6 with the touch stimulus signal (during a touch interval or touch mode of operation).

As explained above, a display interval and a touch interval are non-overlapping intervals within a display frame (in which the display element region is refreshed with an updated image). A particular touch interval may be within any blanking interval portion of a frame, e.g. a relatively short horizontal blanking interval, or a much longer vertical blanking interval.

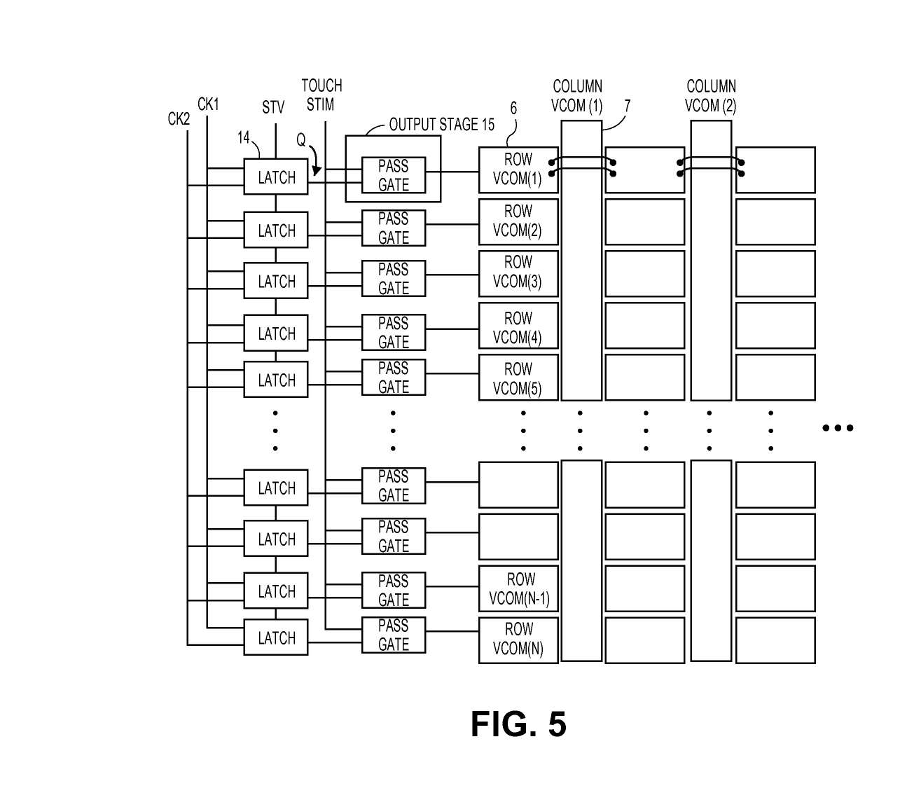

In the approach depicted in FIG. 3, the single trace for the touch stimulus signal may be relatively thin, because it is being used to sequentially drive only one row Vcom segment 6 at a time. Also, in the case of the example output stage 15 shown in FIG. 3, the touch stimulus signal is fed to a signal input of a pass gate whose output is fed through a pair of inverters that act as a buffer gate, before driving the row Vcom segment 6. The buffer gate is a logic gate or digital circuit that provides signal amplification. The pass gate, which may also be referred to as an analog transmission gate, passes its input signal (being the touch stimulus signal) through to the input of the buffer gate, so long as its control input (receiving Q from its respective latch stage 14) is asserted. In such an embodiment, the control input of the output stage 15 is said to be at the pass gate, and its signal input (which is to receive the touch stimulus signal) is also said to be at the pass gate. Thus, the touch stimulus signal in that case sees a high impedance input (the input of an inverter gate). This should be contrasted with other types of output stages 15, including, for example, one where there is no buffer gate between the pass gate and the row Vcom segment 6—see FIG. 5.

An example set of waveforms for performing a touch sensing function using the embodiment of FIG. 3 is shown in FIG. 4. FIG. 4 shows a touch sensing interval in which each Vcom row segment receives a pulse of the touch stimulus signal that coincides with the output Q of its respective latch 14 being asserted. The latch 14 in this example has two clock inputs receiving CK1, CK2, which may have the same frequency but opposite phase such that assertion of CK1 sets the latch output Q while assertion of CK2 resets the latch output Q. The timing of CK1, CK2 should be such that the waveforms depicted in FIG. 4 are produced at the outputs of the latches 14, namely Q(1), Q(2) . . . .

In one embodiment, each touch driver circuit, including its latch 14 and output stage 15, is made essentially of thin film transistors (TFTs) directly on the rear surface of the panel 2, in the border region next to the transparent electrode plate. The touch driver circuitry may be located both to the left side and to the right side of the transparent electrode plate and display element region. In that case, the driving of the row Vcom segments may be interlaced so that, for example, odd numbered rows are driven from the left while even numbered rows are driven from the right.

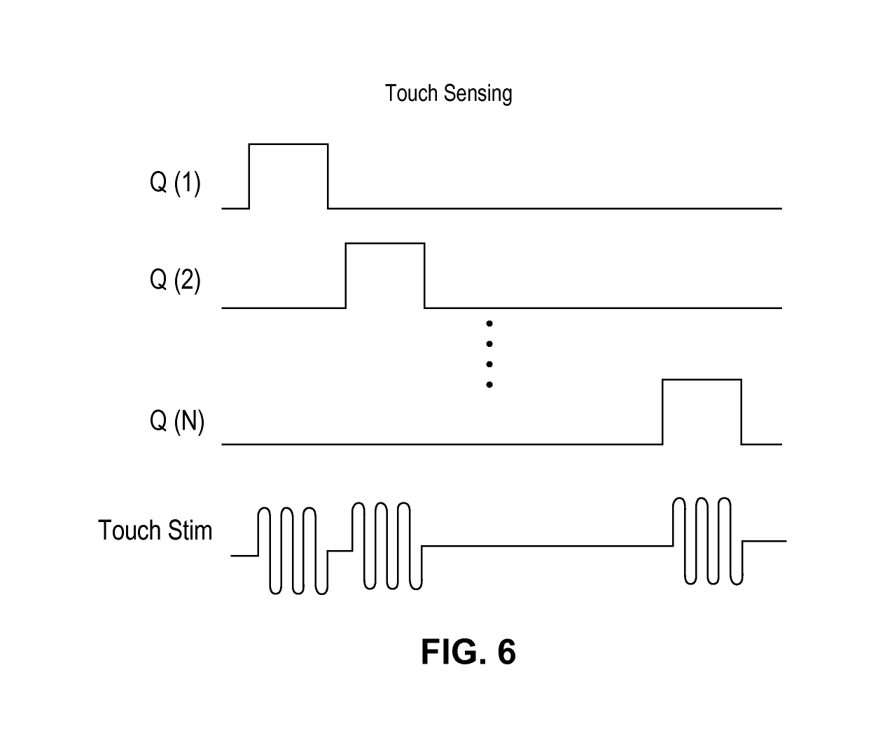

Turning now to FIG. 5, in this embodiment of the touchscreen system, each output stage 15 has a pass gate that is coupled to drive the respective row Vcom segment 6 directly, that is without the use of a buffer gate. As a result, the signal trace used to deliver the touch stimulus signal in this embodiment may need to be somewhat heavier or thicker than the one used in the embodiment of FIG. 4 in which each touch stimulus signal is fed to a high impedance input of a buffer gate. The timing of the signals in the embodiment of FIG. 5 are depicted by an example in FIG. 6, where it can be seen that these are similar to the timing in FIG. 4, namely that the touch stimulus signal is asserted or pulsed through the pass gate, in accordance with assertion of the associated latch output Q. However, one additional aspect to be noted in the embodiment of FIG. 5 and FIG. 6, relative to that of FIG. 3 and FIG. 4, is that the absence of the buffer gate allows the touch stimulus waveform to take on any desired or suitable shape. For example, FIG. 6 depicts a pure sinusoid as the touch stimulus waveform. While a square wave has sharp edges and thus relatively high frequency content, which can contribute to interference or cross-talk between adjacent row Vcom segments, for example due to parasitic capacitance between row Vcom segments, a pure sinusoid is band limited and may therefore help control or limit the generation of such interference or noise.

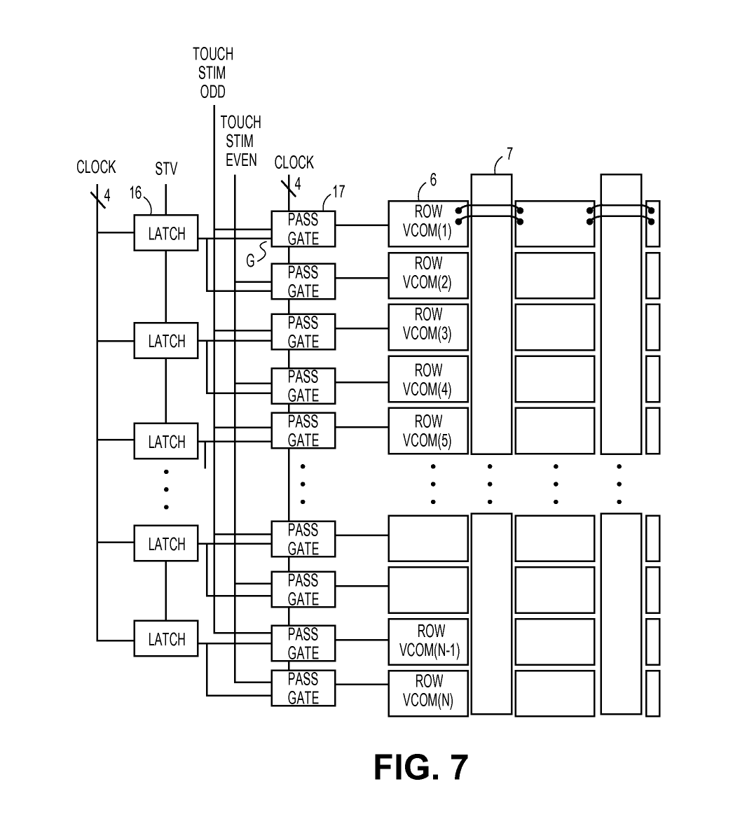

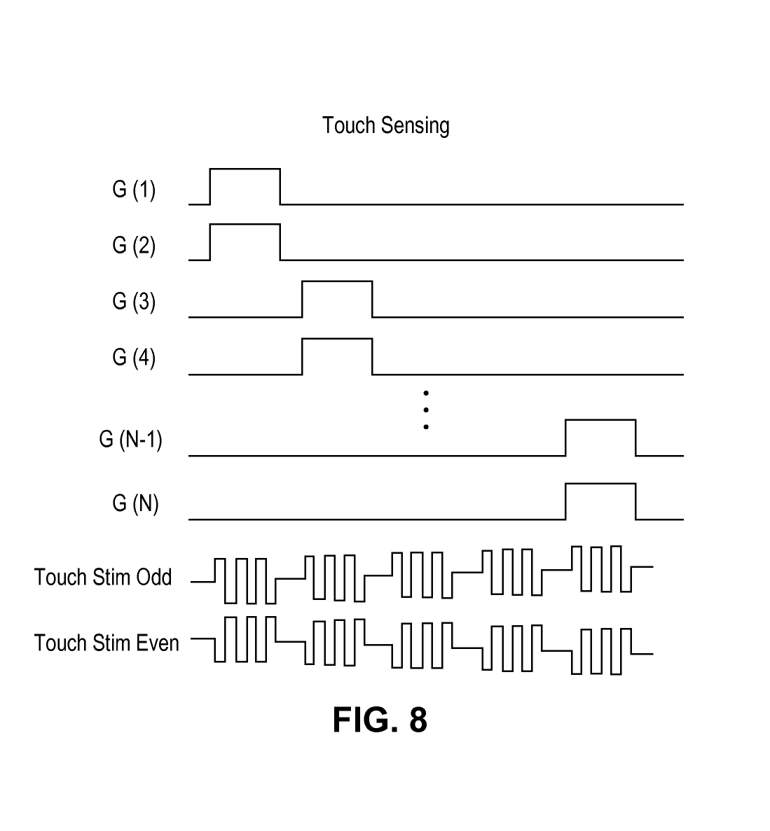

Referring now to FIG. 7, this is another embodiment which may show improved signal to noise ratio for the touch sensing function, in this case using a two-phase stimulation approach. In particular, a pair of touch stimulus signals referred to as touch stimulus odd and touch stimulus even are generated that are 180° out of phase as shown. Although shown as square waves in the time example waveforms of FIG. 8, the odd and even touch stimulus signals need not be square waves any may, for example, be pure sinusoids (especially when the buffer gate is omitted from the output stage, as shown in FIG. 7). The odd touch stimulus signals are fed to odd numbered row Vcom segments 6, while the even touch stimulus signals are routed to even numbered ones. The stimulus signals are fed to the signal inputs of pass gates 17. However in this case, the actual driver circuitry that produces the touch stimulus signals may need to have sufficient drive capability to directly drive the load presented by not a single row Vcom segment, but a pair. In this embodiment, two rows are stimulated at the same time, when a latch 16 associated with that pair has its output Q asserted. In other words, the output Q is fed in parallel to the respective G inputs (control inputs) of two adjacent pass gates 17. Each pass gate 17 may need four clock signals (which may be of the same frequency but all of different phase), as will each latch 16, to ensure that the waveforms depicted in FIG. 8 are produced. There, it can be seen that a pair of adjacent row Vcom segments are turned on simultaneously, where one segment receives an odd stimulus pulse while the other receives an even stimulus pulse that may be 180 degrees out of phase.

Although additional clock signals are needed for the embodiment of FIG. 7, with only a marginal increase in circuit complexity of the latch 16 and pass gate 17 it may present certain advantages including improved signal to noise ratio, due to the use of 180° out of phase adjacent touch stimulus signals. To further reduce the complexity of the touch driver circuitry so as to reduce the needed width in the border region, the embodiment of FIG. 7 omits buffer gates between the outputs of the pass gates 17 and the connections to the Vcom row segments 6. As mentioned above, however, this may require larger signal trace lines for routing the odd and even touch stimulus signals. As in the above embodiments, the touch stimulus signals may actually be generated within the display driver IC 9 (see FIG. 1) or they may be generated off-panel by touch sensing circuitry that is part of a touch controller.

Another variation to the embodiment of FIG. 7 is similar to what was mentioned above with respect to the embodiment of FIG. 4, and that is to drive the row Vcom segments 6 in an interlaced manner. For example, the row Vcom segments 6 may be divided into odd pairs on one side of the Vcom segments, and even pairs on the other side. Thus, in that case, the latch and pass gate which is driving row Vcom segments (3), (4) would be positioned on the right side, as would the latch and pass gate pairs driving row Vcom segments (7), (8), etc.

A method for performing a touch function and a display function can be described as follows. During a display interval, which may be that portion of a frame a raster display in which video data to be displayed is being sent to a touchscreen, a common voltage is applied to a region of display elements using a transparent conductor plate that overlays the display elements and has a grid structure which is coupled to the display elements. This may be achieved as described above using a display mode Vcom conditioning circuit 10 that may be part of a display driver IC 9, while image data (colors) are being written into the display elements. Next, during a touch interval, which may or may not be in the same frame, the grid structure of the transparent conductor plate is sequentially pulsed with a touch stimulus signal, and the grid structure is sensed at the same time in order to detect capacitance changes that indicate the location and, perhaps, the spread of a touch gesture (that may be present on the external surface of the touchscreen panel). Note that the display interval and the touch interval are non-overlapping intervals that may be within the same frame or they may be within different frames, where it is understood that in each frame the display element region is refreshed with an updated image. As an example that was also given above, the touch interval may be within a blanking interval portion of a frame, which may include either a horizontal blanking interval or a vertical blanking interval, where the blanking interval is, generally speaking, the time difference between certain events relating to the display mode of operation and during which the region of display elements not to be updated with color or image data.

In one embodiment, the sequential pulsing of the transparent conductor plate grid structure involves applying the touch stimulus signal to odd numbered rows of the grid structure, and also applying a further touch stimulus signal to even numbered rows of the grid structure. The sequential pulsing may occur a single row at a time (a single row Vcom segment at a time) or it may occur more than one row at a time, for example, as pairs of Vcom segments that are stimulated simultaneously. As mentioned for the embodiment of FIG. 7 described above, the two touch stimulus signals may be 180° out of phase, which may help improve signal to noise ration during the touch sensing mode of operation.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, although the transparent electrode plate was described as being dual-purposed (for touch and display functions) in the context of a liquid crystal cell (which is depicted in FIG. 2), the solutions described for narrowing the border region could also be applicable to touchscreens that use other types of display elements. The description is thus to be regarded as illustrative instead of limiting.

What is claimed is:

1. A touchscreen system comprising:
a light transparent panel;
a region of display elements formed on the panel;
a transparent conductor plate that overlays the region of display elements and is made of a plurality of first electrode segments, wherein the transparent conductor plate is electrically coupled to the display elements; and
a plurality of touch driver circuits positioned on the panel and in a border region thereof, wherein each touch driver circuit has a respective latch and a respective output stage, the latch having a) a clock input and b) an output that is coupled to a control input of the output stage, wherein the output stage is coupled to a respective one of the plurality of first electrode segments and has a signal input to receive a touch stimulus signal.

2. The touchscreen system of claim 1 wherein each touch driver circuit is made essentially of thin film transistors (TFTs).

3. The touchscreen system of claim 1 wherein the border region covers the area between an edge of the panel and an edge of the transparent conductor plate or an edge of the display element region.

4. The touchscreen system of claim 1 wherein the respective output stage comprises a respective pass gate coupled to drive the respective one of the first electrode segments through a respective buffer gate.

5. The touchscreen system of claim 1 wherein the respective output stage comprises a respective pass gate coupled to drive the respective one of the first electrode segments directly.

6. The touchscreen system of claim 1 further comprising a voltage conditioning circuit that is coupled to the plurality of first electrode segments, to provide the display elements with a common voltage during a display interval or display mode of operation.

7. The touchscreen system of claim 1 wherein the transparent conductor plate further comprises a plurality of second electrode segments that overlay the region of display elements.

8. The touchscreen system of claim 7 further comprising a touch sense amplifier circuit that is coupled to the plurality of second electrode segments.

9. The touchscreen system of claim 8 wherein each of the first electrode segments is oriented horizontally and each of the second electrode segments is oriented vertically.

10. The touchscreen system of claim 1 further comprising:
an integrated circuit (IC) installed on the panel and being coupled to receive digital video display information through a flexible circuit carrier from an off-panel display processor or an off-panel frame buffer memory, the IC being coupled to provide pixel color voltages to the display elements based on the received digital video display information, to update the display elements during a display interval.

11. The touchscreen system of claim 1 wherein the respective output stage is coupled to drive a further respective one of the plurality of first electrode segments using a further touch stimulus signal.

12. The touchscreen system of claim 11 wherein the respective output stage comprises a) a respective pass gate coupled to drive the respective one of the first electrode segments using the touch stimulus signal, and b) a further respective pass gate coupled to drive the further respective one of the plurality of first electrode segments using the further touch stimulus signal, and wherein the respective pass gate and the further respective pass gate are coupled to be controlled by the same output of the latch.

13. A touchscreen system comprising:
means for carrying an electronic component while simultaneously passing light;
means for modulating the light in accordance with an image value for display;
means for delivering a common voltage to the light modulation means while simultaneously passing the light; and
means, carried by the electronic component carrying means, for sequentially pulsing the common voltage delivery means with a touch stimulus signal.

14. The touchscreen system of claim 13 wherein the sequential pulsing means is made essentially of thin film transistors (TFTs).

15. The touchscreen system of claim 13 wherein the sequential pulsing means is positioned in a border region of the electronic component carrying means.

16. A method for performing a touch function and a display function, comprising:
applying, during a display interval, a common voltage to a plurality display elements using a transparent conductor plate that has a grid structure which is coupled to the display elements; and
sequentially pulsing the grid structure of the transparent conductor plate with a touch stimulus signal during a touch interval.

17. The method of claim 16 wherein sequentially pulsing the grid structure comprises applying the touch stimulus signal to odd numbered rows of the grid structure, the method further comprising applying a further touch stimulus signal to even numbered rows of the grid structure.
